(19) United States
(12) Patent Application Publication
(10) Pub. No.: US 2017/0255178 A1
(43) Pub. Date: Sep. 7, 2017

(54) SMART WALL

(71) Applicant: WALL.A.BE INC., San Francisco, CA (US)

(72) Inventor: Michael Logue, San Francisco, CA (US)

(21) Appl. No.: 15/446,993

(22) Filed: Mar. 1, 2017

Related U.S. Application Data
(60) Provisional application No. 62/302,053, filed on Mar. 1, 2016.

(51) Int. Cl. G05B 19/042; G06K 7/10

(52) U.S. Cl. CPC G05B 19/0428; G06K 7/10297; G06K 7/10366; G05B 2219/2642

(57) ABSTRACT

Sensors of smart walls for collecting data regarding are described. A sensor of a first smart wall can generate sensor data regarding a room. That sensor data can be provided to a data portal of a second smart wall and used to determine information regarding the room. Some information can include characteristics of the room, interactions with objects upon a smart wall, and conditions within the smart wall.

### PRIORITY

This application claims priority to U.S. Provisional Patent Application No. 62/302,053 (Attorney Docket No. 120329-8002.US00), entitled “Smart Wall,” by Logue, and filed on Mar. 1, 2016. The content of the above-identified application is incorporated herein by reference in its entirety.

### TECHNICAL FIELD

This disclosure relates to smart walls/doorways, and in particular reconfigurable modular panels having embedded electronics.

### BACKGROUND

Interior remodeling can be a difficult procedure involving demolition of walls and removal of fixtures. New walls can then be built and new fixtures can be installed. For example, a hotel might want to frequently remodel rooms to appeal to changing aesthetic tastes over time. Additionally, rooms might be remodeled to provide new technological advances to guests. For example, the transition from cathode ray tube (CRT) televisions to flat panel televisions resulted in televisions being mounted upon walls in some rooms. As another example, the proliferation of electronic devices (e.g., smartphones) has resulted in universal serial bus (USB) ports available in rooms for guests to recharge their electronic devices with USB cables.

However, remodeling rooms can be expensive. For example, the construction of new walls and installation of new fixtures can include having builders, building inspectors, electricians, plumbers, etc. involved at various phases of the construction. The cost of new walls and new fixtures can also be expensive. Additionally, in the case of a hotel, the downtime in which the room is not available for a guest to book can also result in a loss revenue.

### SUMMARY

Some of the subject matter described herein includes a method for collecting data using sensors of smart walls, including: determining, by a sensor of a first smart wall, sensor data regarding a room; providing, by the sensor, the sensor data regarding the room to a data portal of a second smart wall corresponding to an entryway of the room; and determining, by the data portal, information regarding the room based on the sensor data provided by the sensor, the information including one or more of information regarding characteristics of the room, interactions with an object upon the first smart wall, or conditions within the first smart wall of the room.

In some implementations, the information regarding the room includes one or more of temperature of the room, humidity of the room, occupancy of the room, ambient light of the room, or energy consumption of the room.

In some implementations, the method includes displaying, on a display of the data portal, the information regarding the room.

In some implementations, the data portal is adjacent to a doorway modular component of the second smart wall, the doorway providing the entryway to the room.

In some implementations, the interactions with the object upon the first smart wall is based on a unique identifier corresponding to the first object.

In some implementations, the unique identifier includes one or more of a radio frequency identification (RFID) tag or a near field communication (NFC) tag.

In some implementations, conditions within the first smart wall of the room include characteristics regarding utilities routed through the first small wall.

Some of the subject matter described herein also includes an electronic device, including: one or more processors; and memory storing instructions, wherein the processor is configured to execute the instructions such that the processor and memory are configured to: receive sensor data regarding a room at a data panel of a second smart wall from a sensor of a first smart wall, the data portal of the second smart wall corresponding to an entryway of the room; and determine information regarding the room based on the sensor data provided by the sensor, the information including one or more of information regarding characteristics of the room, interactions with an object upon the first smart wall, or conditions within the first smart wall of the room.

In some implementations, information regarding the room includes one or more of temperature of the room, humidity of the room, occupancy of the room, ambient light of the room, or energy consumption of the room.

In some implementations, the electronic device further includes a display screen, and the processor and memory are further configured to: display, on the display panel, the information regarding the room.

In some implementations, the data portal is adjacent to a doorway modular component of the second smart wall, the doorway providing the entryway to the room.

In some implementations, the interactions with the object upon the first smart wall is based on a unique identifier corresponding to the first object.

In some implementations, the unique identifier includes one or more of a radio frequency identification (RFID) tag or a near field communication (NFC) tag.

In some implementations, conditions within the first smart wall of the room include characteristics regarding utilities routed through the first small wall.

Some of the subject matter described herein also includes a computer program product, comprising one or more non-transitory computer-readable media having computer program instructions stored therein, the computer program instructions being configured such that, when executed by one or more computing devices, the computer program instructions cause the one or more computing devices to: receive sensor data regarding a room at a data panel of a second smart wall from a sensor of a first smart wall, the data portal of the second smart wall corresponding to an entryway of the room; and determine information regarding the room based on the sensor data provided by the sensor, the information including one or more of information regarding characteristics of the room, interactions with an object upon the first smart wall, or conditions within the first smart wall of the room.

In some implementations, the information regarding the room includes one or more of temperature of the room, humidity of the room, occupancy of the room, ambient light of the room, or energy consumption of the room.

In some implementations, the processor and memory are further configured to display, on a display panel of the data panel, the information regarding the room.

In some implementations, the data portal is adjacent to a doorway modular component of the second smart wall, the doorway providing the entryway to the room.

In some implementations, the interactions with the object upon the first smart wall is based on a unique identifier corresponding to the first object.

In some implementations, the unique identifier includes one or more of a radio frequency identification (RFID) tag or a near field communication (NFC) tag.

Some of the subject matter described herein also includes a smart wall including: a first portion configured to house a removable modular component providing an amenity for a room including the smart wall; and a second portion configured to route utilities through the smart wall, the second portion also including one or more sensors to monitor one or both of conditions within the second portion of the smart wall or conditions regarding the mechanisms used to route the utilities through the smart wall to determine a problem regarding the utilities in the second portion of the smart wall.

### BRIEF DESCRIPTION OF THE DRAWINGS

FIG. 1 illustrates an example of sensors in a smart wall environment.

FIG. 2 illustrates a block diagram for sensors in a smart wall environment.

FIG. 3 illustrates a block diagram for determining characteristics of a room in a smart wall environment.

FIG. 4 illustrates an example of a room with frames upon which modular components can be installed.

FIG. 5 illustrates an example of a room with modular components installed upon the frames to provide a smart wall environment.

FIG. 6 illustrates an example of a data portal of a smart wall environment.

FIG. 7 illustrates an example of providing feedback in response to interaction with an object upon a smart wall.

FIG. 8 illustrates an example of a double-sided smart wall for a retrofit construction.

FIG. 9 illustrates examples of a single-sided smart wall and a double-sided smart wall for new construction.

FIG. 10 illustrates an example of a data portal.

### DETAILED DESCRIPTION

This disclosure describes devices and techniques for smart walls having embedded electronics such as sensors for determining characteristics of a room enclosed by the smart walls (e.g., conditions in front of the smart walls), determining interactions with objects upon the smart walls of the room, and determining conditions within the smart walls of the room. In one example, the walls of a hotel room can be made with frames upon which modular components can be installed. The modular components can be removed, allowing for the reconfiguration of the hotel room. For example, one modular component can provide a flat screen television and it can be installed within a frame. That modular component can be removed and replaced with another providing a wine rack holding wine bottles. Thus, the hotel room can be easily remodeled by swapping out modular components installed upon the frames. The hotel room can have several modular components installed to provide different amenities to guests. More details regarding a modular panel system are discussed in U.S. Pat. No. 8,713,857, entitled “Modular Panel System,” by Logue, the content of which is incorporated herein by reference in its entirety.

Some of the modular components and/or frames can include sensors, display devices, input devices, and other electronic functionality to enable a smart wall. For example, some of the frames can include a camera or motion detector that can be installed at the top (e.g., close to the ceiling) or the bottom (e.g., close to the floor) that can be used to determine whether the room is occupied. As another example, some of the frames can include a temperature sensor that can be used to provide a temperature of the room. These can allow for the characteristics of the room enclosed by the smart wall to be determined (e.g., whether the room is occupied, the temperature of the room, etc.). That is, characteristics of the environment in front of the smart wall can be determined.

Sensors embedded within the frames of the smart wall can also determine the conditions within the walls. For example, the frames can be composed of three layers including a front layer (upon which modular components can be installed), a back layer (upon which modular components can also be installed in some configurations), and a middle layer positioned between the front layer and the back layer that can be adapted for various uses including a pipe providing water, air ducts providing air conditioning, insulation for noise and/or as a fire retardant, etc. In one example, sensors within the frame can determine the water pressure of the pipe, presence of moisture within the wall, etc. to determine that the pipe within the wall has a leak. As a result, building management can be alerted to fix the pipe. As a compliment or alternative to monitoring plumbing water pressure, air sensors can detect mildew, high humidity, or mold particles. As other examples, the water usage, electrical usage, air circulation, etc. can also be monitored. Thus, the various utilities (e.g., water, air, electricity, etc.) for the room can be monitored.

Sensors can also be used to determine whether guests are interacting with objects placed on the modular components. For example, a modular component having a wine rack stocked with wine bottles can be installed. A radio frequency identification (RFID) reader of the frame (or the modular component) can interact with RFID tags placed upon the wine bottles. When a wine bottle is removed from the wine rack, the RFID tag can be read by the RFID reader and information regarding that wine can be displayed on a display screen of a modular component for the guest to learn more about the wine. Thus, interactions with the smart walls can be determined (e.g., using unique identifiers such as RFID tags of objects upon the walls being interacted with) and a response can be provided to a guest.

The data from the sensors can be provided to a controller installed within a control panel, or data portal, portion of a frame of a smart wall in which a door is also installed. For example, the temperature data can be collected by a sensor from one smart wall frame and provided to a data portal of a smart wall with the door (e.g., the data portal can be adjacent to the door when installed within the smart wall). The temperature of the room can then be displayed on a display screen next to the door. The data portal portion can include other modular components that can use and provide feedback based on the data received by the sensors. In some implementations, the sensors discussed herein can also be installed in the modular components.

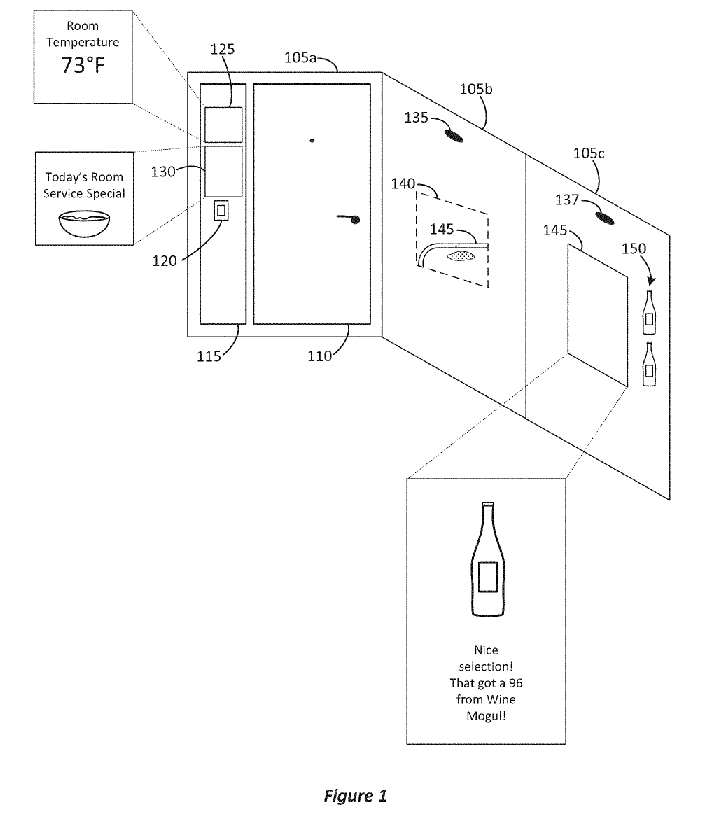

In more detail, FIG. 1 illustrates an example of sensors in a smart wall environment. In FIG. 1, three smart walls 105a, 105b, and 105c form a portion of an enclosure for a hotel room. In FIG. 1, some of the smart walls 105a-c include modular components. For example, smart wall 105a includes door 110 and data portal 115. Smart wall 105c includes display 145, wine rack 150, and temperature sensor 137. Smart wall 105b includes sensor 135 and sensors within interior 140 monitoring leakage from pipe 145. Sensors 135 and 137 can be parts of modular components, or they can be fixed within the frame of smart wall 105b.

While FIG. 1 illustrates a hotel room, a number of different types of rooms can make use of smart walls 105. A residential home, an office building, a banquet hall, and a commercial store/restaurant can all make use of data provided by smart walls 105. The primary differences between each type of building are user interface or intended user related. A hotel interface data portal 115 is directed towards guest concerns. A residential data portal 115 is directed towards ownership concerns. Where multiple data portals 115 are linked together, a central output portal in communication with all data portals 115 has an interface intended for a maintenance or management personnel.

In FIG. 1, data portal 115 can house displays, controls, etc. for a user as well as circuitry that can be used to receive data from sensors, process the data, and act based on the data (e.g., display the temperature of the room on display 125 based on temperature data received from sensor 137 of smart wall 105c). Thus, a processor circuit housed within data portal 115 can be used to determine information regarding the room such as characteristics of the room enclosed by smart walls 105a-c, determine interactions with objects upon the smart walls of the room, and determine conditions within the smart walls of the room. Additionally, data portal 115 includes light switch 120 providing the ability to turn on and off the lights of the room and display 130 (e.g., providing information regarding room service) can also be provided within data portal 115. Because data portal 115 is next to door 110, this provides information regarding the room as well as controls for the room that can be easily accessible at the entry and exit location (e.g., entryway) for the hotel room.

Despite the positioning portrayed in FIG. 1, the data portal 115 may be positioned in any of the smart walls 105a-c. Each sensor disclosed may be positioned in any smart wall 105a-c in a given room.

Regarding determining characteristics of the room enclosed by smart walls 105a-c, an example in FIG. 1 can be camera 135 and temperature sensor 137 that can be used to determine the occupancy and temperature of the room, respectively. For example, camera 135 can be used to determine whether a guest is currently in the room. Either the video data providing image frames of the room, or data indicating that the room is occupied based on the usage of camera 135, can be provided to data portal 115. As another example, temperature sensor 137 can determine the temperature of the room and provide temperature data representing the measured temperature to data portal 115. The temperature can then be displayed on display 125. Thus, characteristics of the room can be determined using sensors embedded within the smart walls.

Regarding determining interactions with objects upon the smart walls of the room, an example in FIG. 1 can be wine rack 150 housing wine bottles. Each of the wine bottles can include an identifier such as an RFID tag and wine rack 150 can be a modular component including a processor circuit with an RFID reader that can read the RFID tag of a wine bottle lifted off the rack and then display information regarding the wine bottle on display 145. That is, as a guest interacts with the wine bottles mounted on a modular component (e.g., wine rack 150) affixed to smart wall 105c, that interaction can be detected to provide information regarding the interaction (e.g., displaying a score for the wine bottle from a wine reviewer) for the guest.

Regarding determining conditions within the smart walls of the room, an example in FIG. 1 can be sensors within interior 140 monitoring leakage from pipe 145. For example, in FIG. 1, pipe 145 can have a leak, resulting in water seeping from pipe 145 and into interior 140 of smart wall 105b. Smart wall 105b can include sensors to determine the water pressure of pipe 145, sensors to determine the humidity or moisture within interior 140, etc. that can be correlated with a leakage of pipe 145. This information can be provided to data portal 115 and used to alert the hotel management to the problem. For example, the hotel management can then call a plumber to fix the leakage of pipe 145.

By having a variety of sensors and electronic functionality provided by modular components and the smart walls, a significant amount of data regarding the room enclosed by the smart walls can be collected. Additionally, by swapping out modular components, new functionality can be integrated for use by the guest, for example, by having the circuitry of data portal 115 communicate with the sensors of the room to collect the corresponding data for processing.

In some embodiments, multiple rooms in a given building include a smart wall 105. Where there are multiple rooms with smart walls 105, additional comparative or analytical functionality is enabled. Data portals 115 of multiple rooms may communicate with a central server or amongst one another in a local or remote cloud.

One such function is monitoring of sound across the given building. Where the smart walls 105 are equipped with a microphone, the propagation of sound across the building can be analyzed. Particular sounds can be isolated and tracked. A given spoken sentence detected by a microphone in a room other than the sentence was spoken demonstrates the effectiveness of the sound proofing of each room.

Where privacy concerns in rooms is important, the microphone may be replaced with a decibel sensor, thus the output of the sensor is merely a number rather than a particular audible/recorded sound. Isolating a given sound becomes less accurate, but is still possible. A high decibel sound in a given room can still be detected in neighboring rooms. Accordingly, the decibel sensor in adjacent rooms provides a numerical rating for sound proofing. A given sound at a known decibel level in one room is heard at a second known decibel level in an adjacent room. The difference between the two decibel levels is the effectiveness of the sound proofing.

Other cloud functions of multiple smart walls 105 positioned in multiple rooms can also be used to monitor temperatures, power usage, and other issue identified by individual sensors across a building. Sensors used in aggregate communicate trends and provide building management data about building maintenance issues.

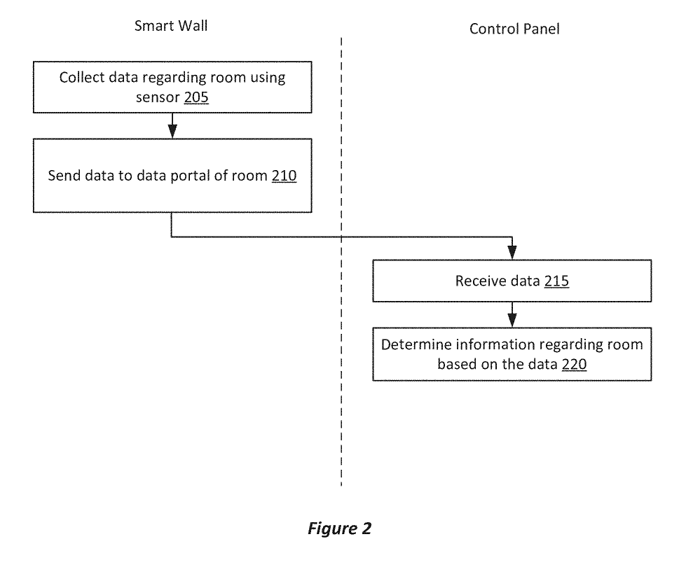

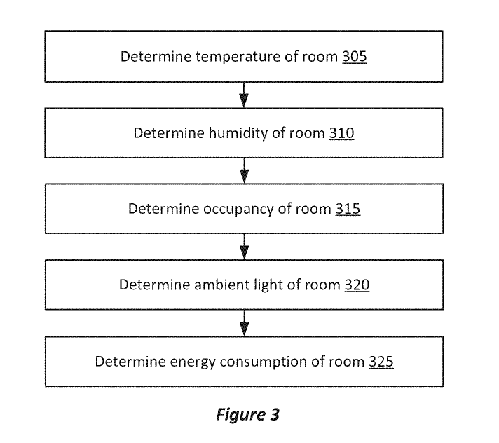

FIG. 2 illustrates a block diagram for sensors in a smart wall environment. In FIG. 2, at block 205, data regarding a room can be collected using a sensor of a smart wall. For example, in FIG. 1, camera 135 can be used to generate data indicating that a guest is currently in the room (i.e., that the room is occupied). Other sensors, such as motion detectors, can also be used to determine the occupation status of the room. As another example, temperature sensor 137 can be used to generate temperature data indicating the current temperature of the room in the vicinity of temperature sensor 137. Other data, such as whether pipe 145 is leaking, whether the guest has taken a wine bottle off of wine rack 150, etc. can also be collected and, at block 210, sent to a control panel of the room. The data can be received by the data portal at block 215. For example, the data can be received by a processor circuit of data portal 115. At block 220, the processor circuit can determine information regarding the room using the received data. For example, the temperature of the room, whether pipe 145 has a leak, or any of the other examples disclosed herein can be determined. Based on some of this information, characteristics of the room can be determined. FIG. 3 illustrates a block diagram for determining characteristics of a room in a smart wall environment. In FIG. 3, the temperature of the room (305), humidity of the room (310), occupancy of the room (315), ambient light within the room (320), and energy consumption of the room (325) can be determined using the data provided by the smart walls to the control panel.

For example, multiple temperature sensors from multiple smart walls can provide temperature data to data portal 115. Data portal 115 can then use multiple temperature data together to provide a temperature for the room to be displayed on display 125. For example, the temperatures can be averaged to provide a single temperature to be displayed. If a new modular component is installed onto a frame of one of the smart walls and if that new modular component includes a temperature sensor, then this can represent a new source of temperature data for data portal 115 to receive temperature data from and take into account when determining the temperature of the room. Similar functionality can be provided for determining the humidity of the room, for example, using a hygrometer. Using this data, data portal 115 can adjust the conditions in the room. For example, the air conditioner can be turned on if the temperature and/or humidity reach certain threshold values or ranges.

The occupancy of the room can be determined using cameras, motion detectors, or other devices. Whether a room is occupied or not can be determined, as well as more detailed information such as the number of occupants. Using this data, control panel 115 can alert the hotel management whether the occupancy of the room exceeds a set value. For example, if a room is to have a maximum of four occupants, but five occupants are determined to be in the room, then a message can be provided to the hotel management so that they can be aware of the situation.

The ambient light of the room can also be determined using ambient light sensors fixed within the frames of the smart walls or within the modular components attached to the smart walls. Similar to the determination of temperature, multiple measurements of the ambient light can be made by different ambient light sensors and provided to data portal 115. Based on the determination of the ambient light in the room, data portal 115 can adjust the lighting conditions in the room. For example, a window shade can be retracted to allow more sunlight into the room during daylight hours. As another example, lights distributed within the room (e.g., lights of modular components on smart walls) can be turned on to provide illumination during nighttime hours.

The energy consumption of a room can be determined by each of the smart walls providing energy usage (e.g., current, watts, etc. that can be correlated with energy used) to data portal 115. For example, each of the smart walls can monitor the energy usage of the modular components installed (e.g., by monitoring energy usage of each modular component separately or the energy usage of the entire smart wall providing multiple modular components by monitoring the electrical wiring routed through the smart wall that is used to power the modular components, as discussed elsewhere herein) and provide data regarding the overall energy usage of each smart wall to data portal 115. If the energy usage is high (e.g., above a threshold) and if the occupancy of the room is determined to be empty, then data portal 115 can turn off the usage of the electricity for certain of the smart walls. For example, the energy consumption of each of the smart walls can be aggregated and the smart wall consuming the most energy can be provided an instruction by data portal 115 to turn off electricity provided to its modular components. Thus, energy can be managed for each smart wall.

Thus, many of the characteristics can be determined and a variety of actions can be performed based on the determined characteristics. In some implementations, data portal 115 can include several display screens, as previously discussed, such as display 130. The content of display 130 can change based on the determined characteristics. For example, in FIG. 1, display 130 informs guests regarding a special regarding room service. In some implementations, the number of occupants determined to be in the room can be determined and the content displayed on display 130 can be changed based on the number of occupants. For example, if more than four persons are in the room, then display 130 can display information regarding reserving a table for four at the hotel restaurant. If one person is in the room, then information regarding requesting room service can be displayed.

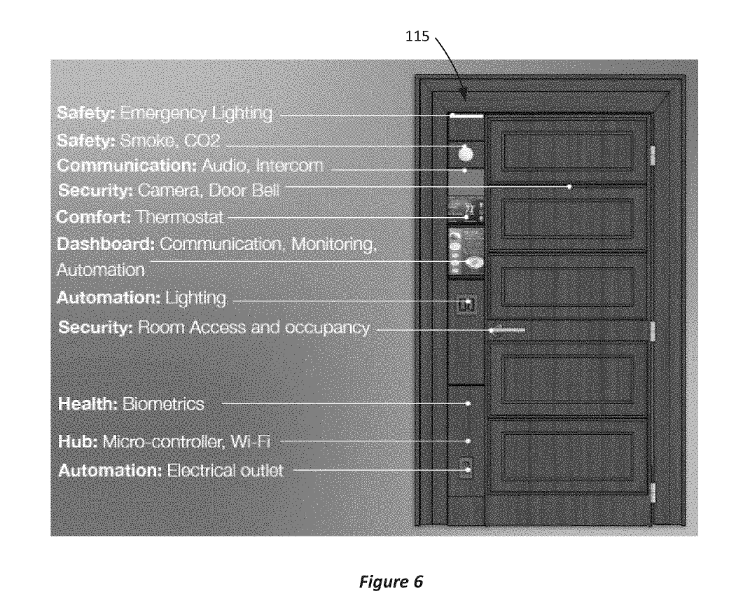

In some implementations, data portal 115 can also include carbon dioxide detector, carbon monoxide detector, smoke detector, thermostat, and other systems that can be useful for the guest. FIG. 6 illustrates an example of a data portal of a smart wall environment. In FIG. 6, data portal 115 includes emergency lighting, a smoke detector, carbon dioxide detector, and camera-based peep hole (e.g., displaying the environment in front of the door on a display screen) for safety. In FIG. 6, an intercom can be provided for communications (e.g., with persons outside of the door, with hotel management, with guests of other rooms, etc.), a thermostat can be provided for comfort, and a dashboard can be provided to display data related to the smart walls (e.g., the temperature of the room), and automation purposes as disclosed herein. Also depicted in FIG. 6 include biometrics for health purposes and an electrical wall outlet. Regarding biometrics, some of the sensors of the smart walls can include infrared sensors that can detect body heat. If a guest is determined to be hot (e.g., suggesting a fever), then the guest can be alerted that they might want to take medication. Other sensors can include radon, mildew, and mold, carbon dioxide and carbon monoxide.

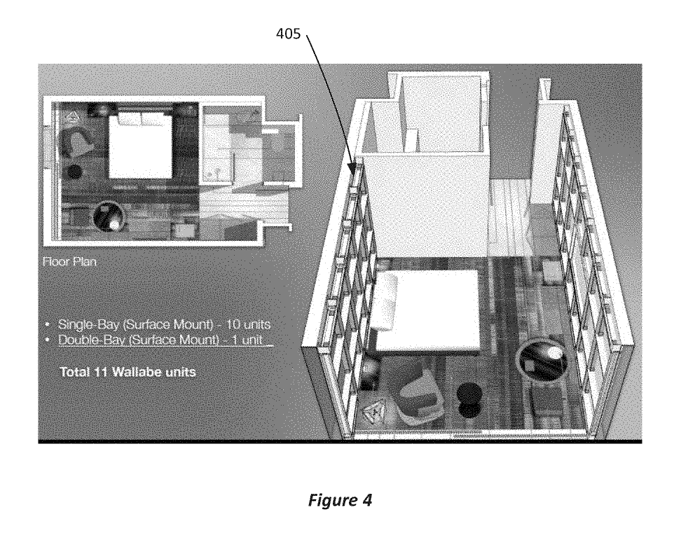

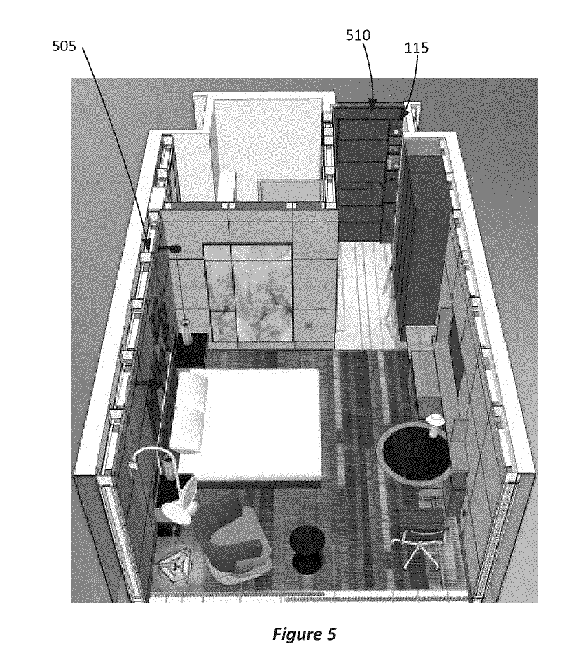

FIG. 4 illustrates an example of a room with frames upon which modular components can be installed. In FIG. 4, frame 405 is one example of a frame upon which modular components can be installed. As depicted in FIG. 4, the frames are distributed along the periphery of the room. FIG. 5 illustrates an example of a room with modular components installed upon the frames to provide a smart wall environment. In FIG. 5, modular components have been installed upon the frames, including modular component 505 and 510 providing electrical lighting and a door with data portal 115, respectively. Different modular components can be installed to provide different functionalities, as previously discussed.

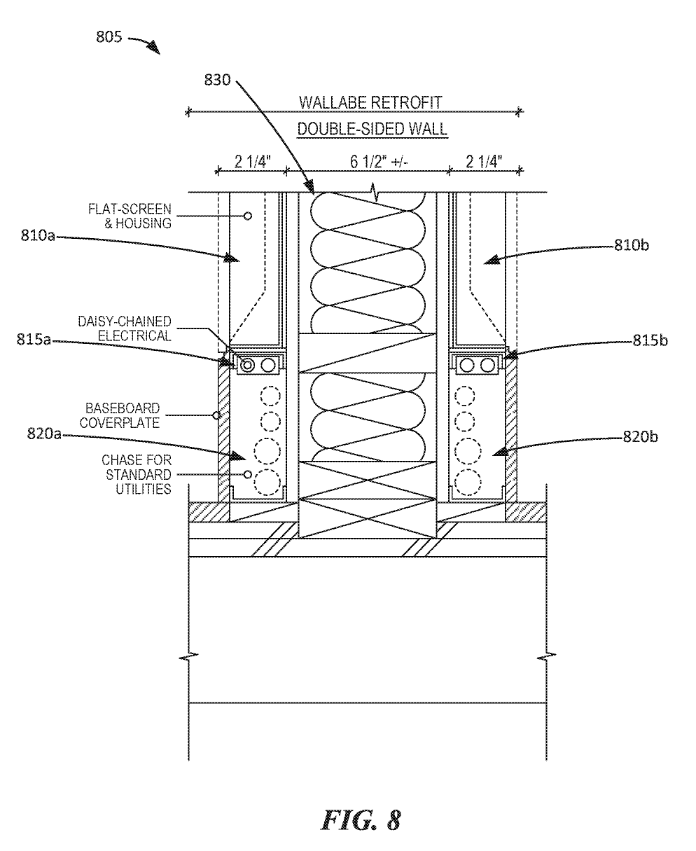

FIG. 8 illustrates an example of a double-sided smart wall for a retrofit construction. In FIG. 8, smart wall 805 depicts a retrofit, for example, configuring a pre-existing wall 830 to be able to be support the modular components discussed herein by constructing the frames on the opposite sides. In FIG. 8, modular components can be installed upon either side of a pre-existing wall to provide a double-sided smart wall. That is, modular components can be mounted in portions 810a and 810b on opposite sides of pre-existing wall 830 in a retrofit application. Utilities can be propagated between the walls in a chase 820a and 820b at the bottom as depicted in FIG. 8, and daisy-chained electrical interconnect 815a and 815b can allow for each smart wall to provide power to the various electrical functionalities discussed herein. For example, chase 820a and 820b can include pipes for water, ducts for heating, ventilation, and air conditioning (HVAC), etc. By routing utilities via chase 820a and 820b, sensors as disclosed herein can be added to monitor the conditions of the pipes, ducts, fittings, and other mechanisms of propagating utilities to appropriate fixtures within the room, the bathroom of the room, or other locations (e.g., other rooms, common spaces such as hallways, etc.). For example, the sensors can be integrated into the mechanisms (e.g., inserting a sensor into a pipe), onto the mechanisms (e.g., placing a sensor on a pipe), or within the chase (e.g., within the environment surrounding the pipe). Thus, smart wall 805 can include portions to house a modular component (e.g., portions 810a and 810b, which can be provided electricity by the utilities routed through the smart wall), and portions to route utilities and monitor those utilities (e.g., chase 820a, chase 820b, and the portions corresponding to daisy-chained electrical interconnect 815a and 815b). The utilities can thus be routed from one smart wall to another smart wall with sensors in many of the smart walls to determine the various conditions as described herein. Additionally, the mechanisms used to propagate or route the utilities (e.g., the pipes, ducts, wires, etc.) can be easily serviced because they can be accessed without having to open up pre-existing wall 830.

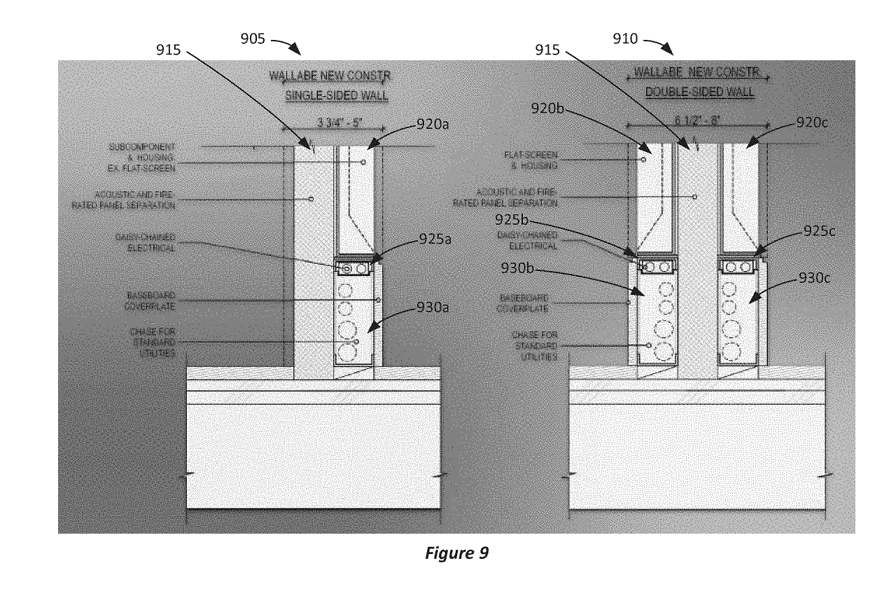

FIG. 9 illustrates examples of a single-sided smart wall and a double-sided smart wall for new construction. In FIG. 9, smart wall 905 and smart wall 910 depict single-sided and double-sided walls, respectively, for new construction. That is, smart walls 905 and 910 can be constructed for new rooms or new buildings rather than built adjacent to or upon pre-existing walls as previously described. For example, smart wall 905 can include one portion 920a upon which modular components can be installed (and another portion 915 which can provide acoustic and/or fire rated separation between rooms (i.e., rooms separated by smart wall 905). For example, portion 915 can include insulation material for acoustic and/or fire-rated panel separation that can comply with building code requirements of the jurisdiction in which smart wall 905 is being constructed. For example, construction of some hotels might require certain fire resistance ratings in the case of a fire, acoustic dampening to reduce room-to-room noise, etc. Various insulation materials can be placed within portion 915 to provide these. Similar to the example of FIG. 8, portion 920a can be used to mount a modular component as discussed herein, daisy-chained electrical utilities 925a and chase 930a can be used to route utilities among the smart walls. Portion 920a, daisy-chained electrical utilities 925a, and chase 930a are accessible form the same side of portion 915. The utilities can be monitored by placing the sensors within the utilities, upon the mechanisms used to propagate the utilities, and/or within chase 930a.

In FIG. 9, smart wall 910 can include three portions, two portions upon which modular components can be installed (e.g., portions 920b and 920c), both of which are separated by an acoustic and/or fire rated separation portion 915. Thus, in contrast to smart wall 905, smart wall 910 includes the capability to have modular components on either side of portion 915. Daisy-chained electrical interconnect 925b and 925c, and chase 930b and 930c can be route the utilities, as previously described. Sensors can also be placed within these to monitor the various conditions as described herein.

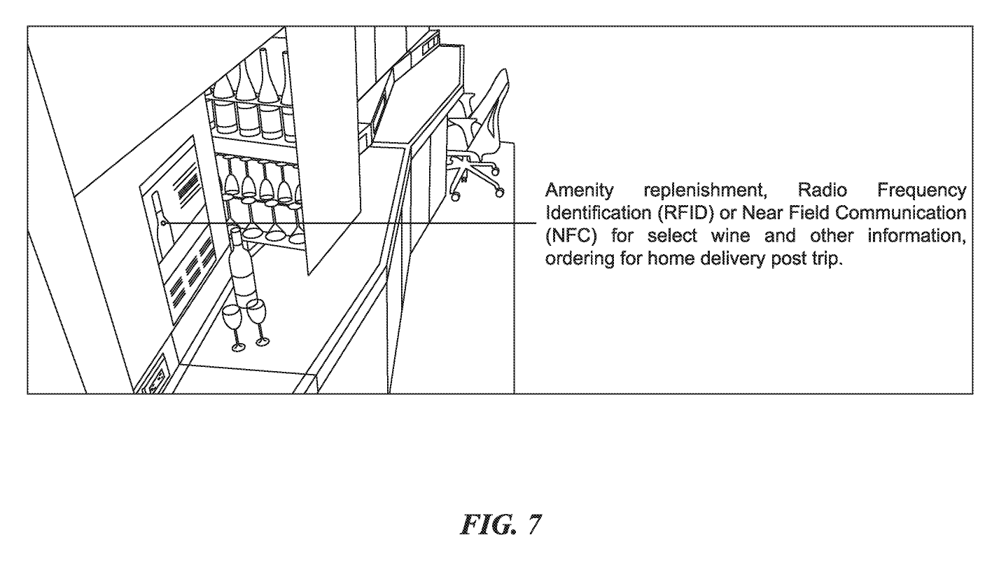

As previously discussed, interaction with the smart walls can also be determined, for example, a guest removing a wine bottle mounted on a wine rack modular component, as previously discussed. FIG. 7 illustrates an example of providing feedback in response to interaction with an object upon a smart wall. In FIG. 7, display 705 can provide information regarding a wine bottle removed from a wine rack, as previously discussed. RFID or near field communication (NFC) tags can be attached to the wine bottles and as they are removed from the wine rack, this can be detected and information regarding the wine bottle can be displayed (e.g., price, rating, etc.). In some implementations, the guest can be provided with information regarding ordering the bottle of wine for home delivery, for example, upon checkout from the hotel.

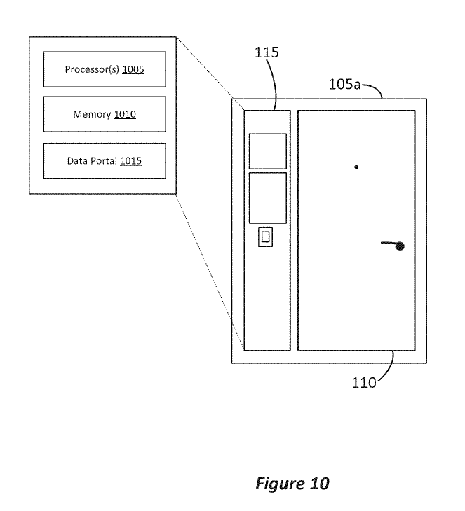

FIG. 10 illustrates an example of a data portal. In FIG. 10, data portal 115 can include one or more processors 1005 (e.g., circuits) and memory 1010 storing instructions that can be executed by processors 1005 to implement data portal 1015 providing the functionality described herein. For example, processors 1005 and memory 1010 can implement data portal 1015 to collect information from sensors of other smart walls, process such information, and act based on the information as described herein. Data portal 115 can also include display screens, touch sensors, etc. Memory 1010 can be non-transitory computer-readable storage media. Such components and functionality can also be implemented within smart walls 105b and 105c in FIG. 1. For example, processors and memory can also be within frames and/or modular components to provide the functionality described herein.

From the foregoing, it will be appreciated that specific embodiments of the invention have been described herein for purposes of illustration, but that various modifications may be made without deviating from the scope of the invention. Accordingly, the invention is not limited except as by the appended claims.

I/we claim:

1. A smart wall, comprising:
a first portion configured to house a removable modular component providing an amenity for a room including the smart wall; and
a second portion configured to route utilities through the smart wall, the second portion also including one or more sensors to monitor one or both of conditions within the second portion of the smart wall or conditions regarding mechanisms used to route the utilities through the smart wall to determine a problem regarding the utilities in the second portion of the smart wall.

2. The smart wall of claim 1, wherein the smart wall further includes one or more sensors configured to generate sensor data regarding the room to determine information regarding characteristics of the room, interactions with objects upon the smart wall, or conditions within the smart wall.

3. The smart wall of claim 2, wherein the information regarding the room includes one or more of temperature of the room, humidity of the room, occupancy of the room, ambient light of the room, or energy consumption of the room.

4. The smart wall of claim 3, wherein the energy consumption of the room is based on providing electricity to the removable modular component of the first portion of the smart wall using the utilities.

5. The smart wall of claim 1, further comprising:
a third portion configured to provide insulation material of the smart wall, the first portion and the second portion positioned on a same side of the third portion of the smart wall.

6. The smart wall of claim 5, wherein the insulation material includes one or both of acoustic insulation material or fire insulation material.

7. A method for collecting data using sensors of smart walls, comprising:
generating, by a sensor of a first smart wall, sensor data regarding a room;
providing, by the sensor, the sensor data regarding the room to a data portal of a second smart wall corresponding to an entryway of the room; and
determining, by the data portal, information regarding the room based on the sensor data provided by the sensor, the information including one or more of information regarding characteristics of the room, interactions with an object upon the first smart wall, or conditions within the first smart wall of the room.

8. The method of claim 7, wherein the information regarding the room includes one or more of temperature of the room, humidity of the room, occupancy of the room, ambient light of the room, or energy consumption of the room.

9. The method of claim 7, further comprising:
displaying, on a display of the data portal, the information regarding the room.

10. The method of claim 7, wherein the data portal is adjacent to a doorway modular component of the second smart wall, the doorway providing the entryway to the room.

11. The method of claim 7, wherein the interactions with the object upon the first smart wall is based on a unique identifier corresponding to the first object.

12. The method of claim 10, wherein the unique identifier includes one or more of a radio frequency identification (RFID) tag or a near field communication (NFC) tag.

13. The method of claim 7, wherein conditions within the first smart wall of the room include characteristics regarding utilities routed through the first small wall.

14. An electronic device, comprising:
one or more processors; and
memory storing instructions, wherein the processor is configured to execute the instructions such that the processor and memory are configured to:
receive sensor data regarding a room at a data panel of a second smart wall from a sensor of a first smart wall, the data portal of the second smart wall corresponding to an entryway of the room; and
determine information regarding the room based on the sensor data provided by the sensor, the information including one or more of information regarding characteristics of the room, interactions with an object upon the first smart wall, or conditions within the first smart wall of the room.

15. The electronic device of claim 14, wherein the information regarding the room includes one or more of temperature of the room, humidity of the room, occupancy of the room, ambient light of the room, or energy consumption of the room.

16. The electronic device of claim 14, the electronic device further comprising a display screen, and the processor and memory are further configured to:
display, on the display panel, the information regarding the room.

17. The electronic device of claim 14, wherein the data portal is adjacent to a doorway modular component of the second smart wall, the doorway providing the entryway to the room.

18. The electronic device of claim 14, wherein the interactions with the object upon the first smart wall is based on a unique identifier corresponding to the first object.

19. The electronic device of claim 18, wherein the unique identifier includes one or more of a radio frequency identification (RFID) tag or a near field communication (NFC) tag.

20. The electronic device of claim 14, wherein conditions within the first smart wall of the room include characteristics regarding utilities routed through the first small wall.

21. A computer program product, comprising one or more non-transitory computer-readable media having computer program instructions stored therein, the computer program instructions being configured such that, when executed by one or more computing devices, the computer program instructions cause the one or more computing devices to:
receive sensor data regarding a room at a data panel of a second smart wall from a sensor of a first smart wall, the data portal of the second smart wall corresponding to an entryway of the room; and
determine information regarding the room based on the sensor data provided by the sensor, the information including one or more of information regarding characteristics of the room, interactions with an object upon the first smart wall, or conditions within the first smart wall of the room.

22. The computer program product of claim 21, wherein the information regarding the room includes one or more of temperature of the room, humidity of the room, occupancy of the room, ambient light of the room, or energy consumption of the room.

23. The computer program product of claim 21, the electronic device further comprising a display screen, and the processor and memory are further configured to:
display, on a display panel of the data panel, the information regarding the room.

24. The computer program product of claim 21, wherein the data portal is adjacent to a doorway modular component of the second smart wall, the doorway providing the entryway to the room.

25. The computer program product of claim 21, wherein the interactions with the object upon the first smart wall is based on a unique identifier corresponding to the first object.

26. The computer program product of claim 25, wherein the unique identifier includes one or more of a radio frequency identification (RFID) tag or a near field communication (NFC) tag.
